(19) United States
(12) Patent Application Publication
(10) Pub. No.: US 2002/0163440 A1
(43) Pub. Date: Nov. 7, 2002

(54) Programmable universal transmitter

(76) Inventor: Philip Y.W. Tsui, Mississauga (CA)

Correspondence Address: Babak Redjaian, IRELL & MANELLA LLP, Suite 400, 840 Newport Center Drive, Newport Beach, CA, 92660, US

(21) Appl. No.: 09/797,780

(22) Filed: Mar. 1, 2001

(51) Int. Cl. G08C 19/00

(52) U.S. Cl. 340/825.69

(57) ABSTRACT

A universal transmitter that is programmable to transmit one or more identification or device codes, using one or more transmission formats, at one or more transmission frequencies to control one or more respective devices. In one embodiment, the transmitter includes a controller and memory for storing values of multiple device codes, transmission formats, and transmission frequencies programmed by a user. The values stored in the memory are assigned to or associated with one or more actuation switches. Actuation of a switch causes the controller to retrieve from memory a device code, transmission format, and transmission frequency associated with the switch, and to control a voltage controlled oscillator and a radio frequency circuit to transmit a signal having the device code and transmission format, at the transmission frequency.

### BACKGROUND OF THE INVENTION

1. Field of the Invention

The present invention relates generally to remote control systems, and specifically to a universal remote control transmitter that is programmable and capable of transmitting multiple device codes at multiple frequencies, using multiple transmission formats.

2. Background of the invention

Transmitter-receiver controller systems are widely used for remote control and/or actuation of devices or appliances such as garage door openers, gate openers, security systems, and the like. For example, most conventional garage door opener systems use a transmitter-receiver combination to selectively activate the drive source (i.e., motor) for opening or closing the door. The receiver is usually mounted adjacent to the motor and receives a coded signal (typically radio frequency) from the transmitter. The transmitter is typically carried by a user and selectively activated by the user to open or close the garage door. These type of remote control systems typically employ VHF/UHF radio frequency transmissions.

In general, a remote control system has a remote transmitter and a receiver coupled to the device, which is to be controlled. When activated, the transmitter emits a modulated signal, which is recognized by the receiver to activate the device. In VHF/UHF-based systems, a transmitter typically emits a pulse-modulated VHF/UHF signal. The signal embodies a modulation pattern as a sequence of “signal on” and “signal off” intervals. The modulated signal emitted by the transmitter is recognized by the receiver. The modulation pattern of remote control systems is typically unique to restrict unauthorized access to the device being controlled.

Different manufacturers of such transmitter-receiver systems generally utilize different transmission protocols or patterns for transmitting the coded signal. Additionally, the manufacturers typically operate the transmitter-receiver systems at different transmission frequencies within the allocated frequency range for a particular type of system. The modulation pattern typically includes two aspects: 1) a device code (equivalent to a device address) for the transmitter and receiver, and 2) a transmission format, i.e., the characteristics of the transmitted signal including timing parameters and modulation characteristics related to encoded data. The transmission pattern used by one manufacturer is usually incompatible with that provided by other manufacturers.

Currently available transmitter-receiver systems typically employ custom encoders and decoders to implement the transmission pattern. These encoders and decoders are fabricated with custom integrated circuits such as application-specific integrated circuits (ASICs). They are fixed hardware devices and allow very limited flexibility in the encoding/decoding operation or in the modification of the encoding/ decoding operation.

Thus, in such existing transmitter-receiver systems, it is necessary to know the transmission frequency accepted by the receiver and to match or determine the modulation pattern recognized by the receiver. In a number of transmitter-receiver systems, the modulation pattern is determined by setting a plurality of dual inline package (DIP) switches (or a modulation pattern selection circuit) on the transmitter and by similarly setting a plurality of DIP switches (or a corresponding modulation pattern selection circuit) on the receiver. Once the required frequency and the modulation pattern are defined, a compatible transmitter can be provided to operate with the receiver. The DIP switches or the modulation pattern selection circuit may also be manually reset to match the modulation pattern of signals transmitted by a new transmitter to that of the existing receiver. Alternatively, both the existing receiver and new transmitter can be reprogrammed with a new modulation pattern. However, existing reprogramming techniques require prior knowledge of the transmission frequency and modulation protocol of the existing transmitter. In addition, they can only be implemented in compatible transmitters and receivers using complex circuits.

### BRIEF SUMMARY OF THE INVENTION

The present invention comprises a universal transmitter that is programmable to transmit one or more identification or device codes, using one or more transmission formats, at one or more transmission frequencies to control one or more respective devices. In one embodiment, the transmitter includes a controller and memory for storing values of multiple device codes, transmission formats, and transmission frequencies programmed by a user. The values stored in the memory are assigned to or associated with one or more actuation switches. Actuation of a switch causes the controller to retrieve from memory a device code, transmission format, and transmission frequency associated with the switch, and to control a voltage controlled oscillator and a radio frequency circuit to transmit a signal having the device code and transmission format, at the transmission frequency.

Other embodiments are disclosed and claimed herein.

### BRIEF DESCRIPTION OF THE DRAWINGS

FIG. 1 illustrates a block diagram of a typical transmitter-receiver system.

FIG. 2 is a block diagram of a universal transmitter, according to one embodiment of the present invention.

FIGS. 3A and 3B illustrate a detailed diagram of a universal transmitter, according to one embodiment of the present invention.

FIG. 4 illustration a flow diagram of a process or method executed by the CPU, according to one embodiment of the present invention.

FIG. 5 illustrates a flow diagram of a data transmission method, according to one embodiment of the present invention.

FIG. 6 illustrates a flow diagram of a frequency setting and/or device code learning method, according to one embodiment of the present invention.

FIG. 7 illustrates a flow diagram of a method for calibrating the transmission frequency, according to one embodiment of the present invention.

FIG. 8 illustrates a flow diagram of a method for setting a transmission format group, according to one embodiment of the present invention.

### DETAILED DESCRIPTION OF THE PREFERRED EMBODIMENT

The universal transmitter of the present invention is a low-cost remote control transmitter that can be programmed to actuate remote control receivers that recognize a fixed-code pulse-modulated transmission or a rolling code transmission. The transmitter is programmable and can store combinations of transmission frequencies, devices codes, and modulation patterns in memory, and associate multiple combinations with multiple switches for controlling multiple devices. The transmitter includes a controller and a single radio frequency oscillation circuit. Actuation of a switch causes the controller to retrieve a device code, transmission format, and transmission frequency associated with the switch, and to control the radio frequency oscillation circuit to transmit a signal having the device codes and transmission format, at the transmission frequency.

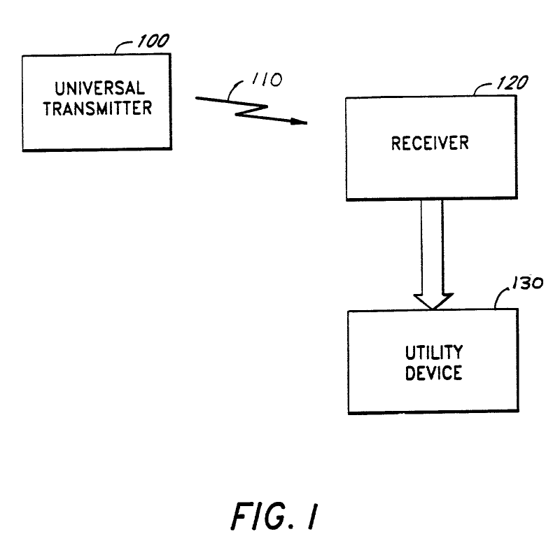

Referring now to the drawings, and in particular to FIG. 1, there is shown a block diagram of a typical transmitter-receiver system. In FIG. 1, universal transmitter 100 is capable of generating an electromagnetic wave represented by the arrow 110. The frequency of the signal 110 generated by transmitter 100 and the encoding and data transmission scheme is a function of the particular transmitter design. The universal transmitter 100 is programmable and can transmit multiple device codes using multiple transmission formats or protocols, at multiple transmission frequencies. A receiver 120 is adapted to receive the signals 110 from the transmitter 100, interpret the signals and produce an output signal to drive a utility device 130.

In a representative utilization, the transmitter 100 is a remote control device which can be used with the receiver 120 as part of a garage door opening system. In this representative utilization, utility device 130 may be the garage door mechanism, including the motor, drive mechanism, lighting apparatus and/or the like. For example, the utility device 130 opens or closes a garage door when activated by receiver 120 upon receipt of the appropriate signal from the transmitter 100. While a garage door opening mechanism is illustrative, many other types of utility devices may be controlled by such remote transmitter-receiver system such as gates, light systems, security systems, etc.

When activated, the programmable transmitter 100 generates a signal 110 having a predetermined transmission frequency and a unique data transmission format, that is, the timing parameters and modulation characteristics related to encoded data are unique to the design of the particular transmitter. The receiver 120 is adapted to receive and decode the signals generated by the transmitter 100 to produce an output signal which is supplied to the utility device 130. In one embodiment, the transmitter 100 and the receiver 120 transmit and receive at a single transmission frequency, using a single data transmission format. In alternative embodiments, multi-format and/or multi-frequency systems may be implemented.

The transmitter 100 and receiver 120 typically have a selectable code (or address) that is set using a plurality of DIP switches in each unit. Identical codes are required for communication between a transmitter 100 and a receiver 120. Setting the DIP switches to identical settings (on or off) in each unit provides identical codes. Communication between the transmitter 100 and receiver 120 is accomplished according to a specific data transmission format which typically is unique to devices provided by the manufacturer of the specific transmitter-receiver system. There are many different transmission formats used by various manufacturers. Exemplary transmission formats are described in U.S. Pat. No. 5,841,390, invented and owned by the inventor and owner of the present application, the contents of which are fully incorporated herein by reference.

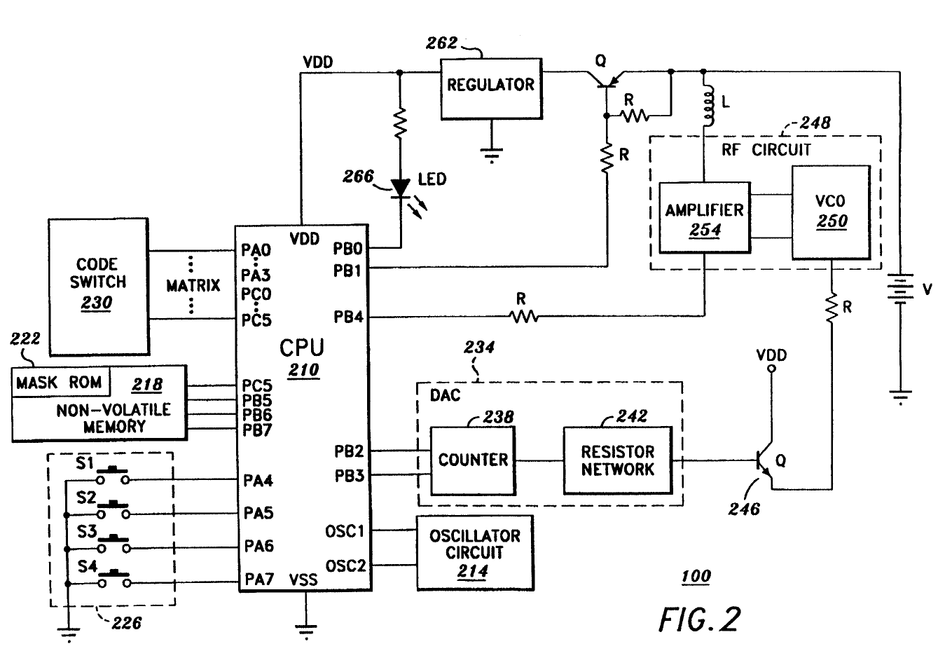

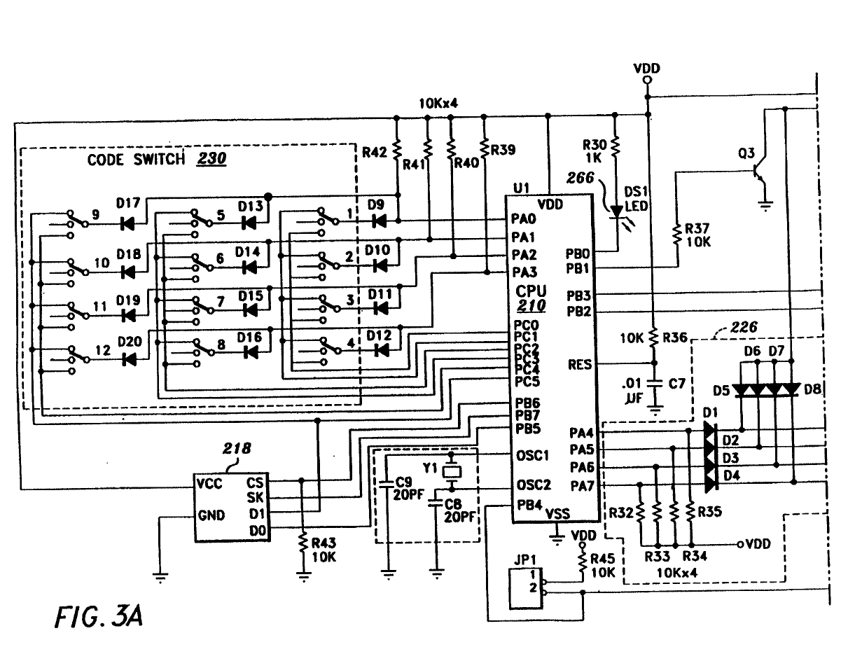

FIG. 2 is a block diagram of a universal transmitter 100, according to one embodiment of the present invention, while FIGS. 3A and 3B illustrate a detailed diagram of the universal transmitter 100 of FIG. 2, according to one embodiment of the present invention. The universal transmitter 100 of the present invention is programmable to transmit one or more device codes using one or more transmission formats at one or more frequencies. This allows the universal transmitter to control many standard receivers. Additionally, the transmitter 100 includes multiple switches (e.g., 4) that can be assigned to control multiple devices simultaneously. Thus, each switch can be assigned to transmit a signal having any combination of a device code, transmission format, and transmission frequency. In one embodiment, the modulation pattern is a pulse-code modulation pattern. However, in alternative embodiments, the transmission pattern may be any known transmission pattern, for example, frequency shift keying, pulse amplitude modulation, and pulse width modulation.

Referring to FIGS. 2 and 3, the transmitter 100 includes a central processing unit (CPU) 210, an oscillator circuit 214, non-volatile memory 218, read only memory (ROM) 222, a plurality of switches 226, code switch 230, digital to analog converter (DAC) 234, summing DC amplifier 246, radio frequency (RF) circuit 248, a voltage regulator 262, and a light emitting diode (LED) 266. The CPU 210 may be a microprocessor, microcontroller, digital signal processor (DSP), etc. The oscillator circuit 214 provides internal timing for the CPU 210. The non-volatile memory 218 is a programmable non-volatile memory such as a non-volatile random access memory (NVRAM), electrically erasable programmable read only memory (EEPROM), flash memory, or other reprogrammable memory for storing time intervals representative of a modulation pattern, values representative of a modulation frequency, device code values from the code switch 230, etc. In one embodiment, the values are stored in and retrieved from the memory 218 serially. In one embodiment, the memory 218 can store between 1,000 to 8,000 or greater bits of information.

The ROM 222 may store the program that controls the CPU 210 as well as other information including, but not limited to, (i) values representative of the preselected transmission frequencies (Table 1), (ii) values representative of data transmission formats and/or groupings (Table 2), (iii) rolling code settings, (iv) other system settings such as settings for X-10 compatible systems, (v) default values for items (i) to (iv), etc. The ROM 222 may be a masked ROM which prevents information contained therein from being overwritten or changed. The ROM 222 may be internal to the CPU 210, or may be a separate device that is coupled to the CPU 210 externally. The transmitter 100 may include a RAM device coupled to the CPU 210, and/or the CPU 210 may include an internal RAM or scratch pad RAM.

The DAC 234 includes a counter 238 and a resistor network 242, as is known in the art. In one exemplary embodiment, the counter 238 is a CD4040 binary counter integrated circuit produced by Motorola. The RF circuit 248 includes, among other components, a voltage controlled oscillator (VCO) circuit 250 and a power amplifier 254. The CPU 210 generates a digital pulse chain, which controls the counter 238 to count up. The output of the counter 238 is applied to the resistor network 242, which converts the digital pulse chain to an analog voltage. Thus, the binary counter 238 and resistor network 242 convert the digital pulse chain provided by the CPU 210 (e.g., from 0 to 5 volts) to an analog output, which increases or decreases in increments (e.g., by 5 millivolts) responsive to the input of the counter 238. This analog voltage connects to the summing DC amplifier 246 which controls the VCO 250. That is, the output from the summing DC amplifier 246 is applied as a control input to the VCO 250. The VCO's frequency is adjustable or tunable via a varactor diode VD1 252. The frequency generated by the VCO 250 is dictated by the magnitude of the control input signal from the summing DC amplifier 246, which is in turn controlled by the CPU 210. In one embodiment, the VCO 250 is tunable to generate signals in the 200 MHz or lower to 1 GHz or higher frequency range. Thus, the CPU 210 can control the frequency of the VCO 250 over a preselected range (e.g. 100 MHz to 1 GHz), by providing a digital pulse chain to the DAC 234 to control the DAC 234 output voltage.

The CPU 210 is also coupled to the amplifier 254 (PB4 output of CPU 210) to provide the device code and transmission format to the amplifier 254 for transmission. The RF circuit 248 includes a transmitting antenna 258 that operates in conjunction with the VCO 250 and amplifier 254 to generate and transmit signals having an identification code and transmission format over the desired frequency range. In one embodiment, as disclosed herein, the antenna 258 operates to generate and transmit signals in the frequency range between about 100 MHz to 1 GHz. The antenna 258 may be part of a resonant network. Additionally, the antenna 258 may be implemented as a trace on a printed circuit board (PCB) or as a preformed wire that is soldered onto the PCB.

In the exemplary embodiment as shown in FIGS. 2 and 3, the plurality of switches 226 include four switches S1 to S4. Each of the switches S1 to S4 is programmable to generate a desired device code, using a desired modulation format, at a desired transmission frequency. Thus, the switches S1 to S4 may be used in conjunction with four different receivers to control four different devices. For example, switches S1 and S2 may be programmed to control two different garage door openers, switch S3 may be programmed to arm/ dis-arm a security system, and switch S4 may be used to control a gate. Alternatively, more than one switch may be used to control different features of a device. For example, switches S1 and S2 may be programmed to control different zones of an alarm system, and switches S3 and S4 may be used to control different lights within a dwelling. Many other embodiments exist for programming and usage of the switches S1 to S4.

The code switch 230 includes a plurality of switches (e.g., 12), which in the embodiment shown (FIG. 3), are tri-state switches. Alternatively, the code switch 230 may include a plurality of dual in-line package (DIP) switches or other type of switches. The code switch 230 selects the device code for the transmitter-receiver pair, and provides appropriate inputs to the CPU 210. The CPU 210 may be programmed to store the device code settings of the code switch 230 in memory 218. Once a switch (e.g., switch S1) is programmed with a device code, modulation pattern, and data transmission frequency, actuation of the switch causes the CPU 210 to retrieve the values from memory 218 and/or ROM 222 and generate a pulse-modulated signal using the programmed modulation pattern at the programmed transmission frequency.

In normal operation, pins 1 and 2 of JP1 are not connected to each other. In a calibration mode, which typically occurs in the factory, pins 1 and 2 of JP1 are connected to each other, to allow tuning/trimming of the transmission frequencies.

When data transmission is activated, the CPU 210 retrieves the device identification code, transmission format (e.g., ON and OFF intervals), and values representative of a transmission frequency, assigned or associated with the switch pressed, from non-volatile memory 218. The CPU 210 outputs the device code and transmission format on the PB4 signal line to the input of amplifier 254, which activates the amplifier 254 during ON intervals and deactivates the amplifier 254 during OFF intervals. The CPU 210 also outputs a digital signal chain (e.g., values) to the DAC 234 to control the VCO 250 to generate the transmission frequency. Consequently, a signal is transmitted with the desired device code and transmission format, with a desired transmission frequency.

A power latch circuit comprising of transistors Q3 and Q4 is set ON during the start of transmission to provide power to the circuit. The LED 266 is switched ON and OFF in accordance with the desired modulation pattern to be transmitted by the universal transmitter 100.

Operation of the programming mode of the universal transmitter 100 will now be described. For sake of illustration, the transmitter 100 is described having nine (9) preselected transmission frequencies and fourteen (14) preselected transmission formats. These preselected transmission frequencies and transmission formats are intended to be illustrative only and not intended to limit the scope of the invention. It is to be appreciated that a different number and different preselected transmission frequencies and different number and different transmission formats may be used.

In the exemplary embodiment, eight (8) of the preselected transmission frequencies, which are stored in ROM 222 or memory 218 (FIG. 2), include the following: 300, 304, 310, 312, 315, 318, 390, and 433.9 MHz. The ninth preselected transmission frequency is a spare. These preset transmission frequencies cover the major frequencies used for most remote control devices on the market for operation of garage door openers, car alarms, gates, lighting systems, and appliances and equipment in access control and security systems. The factory default transmission frequencies 300, 310, 318, and 390 MHz, stored in the non-volatile memory 218 or ROM 222 and preset to the respective switches S1, S3, S4, and S2, are compatible with the major remote control devices on the market. The other transmission frequencies 304, 312, 315, and 433.9 MHz can be set by the user if the transmission frequency of the remote receiver is different from the default transmission frequencies.

Programming a switch (one of S1 to S4) to a desired transmission frequency occurs by (i) pressing and holding the desired switch (one of S1 to S4) for a predetermined amount of time until the LED 266 (FIG. 2) flashes quickly (e.g., 4 seconds), and then releasing the switch, and (ii) selecting the desired transmission frequency for the device being controlled by pressing and holding one or more of the switches according to Table 1 for a predetermined amount of time until the LED 266 flashes slowly (e.g., 4 seconds), and then releasing the one or more switches. Step (ii) should be performed within a certain time of step (i) (e.g., 10 seconds), or else programming will not take effect. Once steps (i) and (ii) are completed, the desired transmission frequency or a pointer thereto, assigned to the desired switch, is stored in non-volatile memory 218 for later retrieval.

TABLE 1

| Switch(es) | Frequency |
|---|---|
| S1 | 300 MHz |
| S3 | 310 MHz |
| S4 | 318 MHz |
| S2 | 390 MHz |
| S1 + S3 | 304 MHz |
| S1 + S4 | 312 MHz |
| S1 + S2 | 315 MHz |
| S2 + S4 | 433.9 MHz |

The code switch 230 includes a twelve (12) position tri-state code pattern, which covers the major brands of remote controls in either DIP or tri-state code patterns. In one embodiment, the code switch 230 includes twelve (12) rows of posts, where each row contains one shunt connector which is placed on the upper, lower, or blank post for different device code combinations. The transmitter 100 is universal in that it is capable of being programmed to store different device codes by means of the code switch 230. Four different device codes may be programmed with the four different switches S1 to S4, allowing the transmitter 100 to control up to four different devices having four different device codes at the same time. In one embodiment, programming of the device code occurs during programming of a transmission frequency. Once programmed, the desired device code is stored in the non-volatile memory 218.

The fourteen (14) preselected transmission formats (formats 1 to 14), stored in memory 218 or ROM 222, cover the major brands on the market. In the illustrative embodiment, Table 2 only shows 10 transmission formats grouped into five (5) groups. However, the table may include more transmission formats and/or groups. The factory default transmission formats, stored in non-volatile memory 218 or ROM 222 and preset to the respective switches S1 to S4, are compatible with the major remote control devices on the market. The transmitter 100 of the present invention is universal in that it is capable of being programmed to generate known code patterns including a fixed code pulse-modulation signal, pulse width modulation, frequency shift keying signal, and different date frame pattern (e.g., rolling code).

Programming a switch (one of S1 to S4) to a desired transmission format or formats occurs by (i) pressing and holding switches S1 and S4 for a predetermined amount of time (e.g., 4 seconds) until the LED 266 (FIG. 2) flashes, then pauses and flashes repeatedly for, e.g., 10 seconds, and then releasing switches S1 and S4, (ii) pressing a desired switch (one of S1 to S4) for a predetermined amount of time (e.g., 4 seconds) until the LED flashes in a fast pace to program the switch, and (iii) selecting a desired transmission format for the device being controlled by pressing and holding one or more of the switches, according to Table 2, for a predetermined amount of time until the LED stops flashing, and then releasing the one or more switches. Step (iii) should be performed within a certain time limit of step (ii) (e.g., 10 seconds), and/or step (ii) should be performed within the certain time limit of step (i) (e.g., 10 seconds). Once steps (i) through (iii) are completed, the desired transmission format or a pointer thereto, assigned to the desired switch, is stored in memory 218 for later retrieval.

TABLE 2

| | Transmission |
|---|---|
| Switch(es) | Format Grouping |
| S1 | Format 1 + |
| | Format 2 + |
| | Format 3 |
| S3 | Format 4 + |
| | Format 5 |
| S4 | Format 6 |
| S2 | Format 7 + |
| | Format 8 + |
| | Format 9 |
| S2 + S4 | Format 10 |

The transmitter 100 also supports a rolling code transmission format provided by a rolling code system such as the Rolling Code Security System provided by Skylink, of Ontario, Canada. In rolling code systems, the modulation pattern varies with each transmission at different data lengths according to an algorithm that is known only by the transmitter-receiver pair. An exemplary embodiment of a rolling code system is described in co-pending U.S. application Ser. No. 09/023,393 entitled “Wireless Rolling Code Security System,” invented and owned by the inventor and owner of the present invention, the contents of which are fully incorporated herein by reference. The rolling code setting including the device code, transmission frequency, transmission format, algorithm, etc. are stored in ROM 222. To program the transmitter 100 to operate as a rolling code system such as the Skylink Rolling Code Security System, switches S3 and S4 are pressed and simultaneously held for a predetermined time (e.g., 3 seconds) until the LED stops flashing, and then the switches are released. This causes the CPU 210 to move the rolling code settings from ROM 222 and store the settings in non-volatile memory 218. To exit from the rolling code system mode, switches S3 and S4 are once again pressed and simultaneously held for a predetermined amount of time (e.g., 5 seconds), and then released. The transmitter 100 then returns to the previous mode before entering the rolling code mode.

The transmitter 100 of the present invention also allows for adjustment or trimming of the transmission frequency within a predetermined tolerance. Consequently, the transmitter 100 is capable of fine tuning the preset transmission frequencies. To enter a frequency adjustment or calibration mode, switches S1 and S3 are pressed and simultaneously held for a predetermined time (e.g., 3 seconds) until the LED flashes quickly, and then released. One of the desired switches S1 to S4 is pressed and held for a predetermined time (e.g., 3 seconds) until the LED flashed quickly, and then released. To fractionally increase the transmission frequency associated with selected switch, switch S1 is pressed one or more times. To increase the transmission frequency by a larger fraction (e.g., 10×), switch S1 is pressed and held for a predetermined time. Conversely, to fractionally decrease the transmission frequency associated with the selected switch, switch S3 is pressed one or more times. To decrease the transmission frequency by a larger fraction (e.g., 10×), switch S3 is pressed and held for a predetermined time. The granularity of the frequency adjustment is set at the factory. In one embodiment, the frequency adjustment step is in a fraction of the number of bits of the DAC 234. Once the transmission frequency is adjusted (up or down), switch S4 may be pressed to confirm the new adjusted transmission frequency, in which case the value is saved in the non-volatile memory 218. On the other hand, switch S2 may be pressed to cancel the operation altogether.

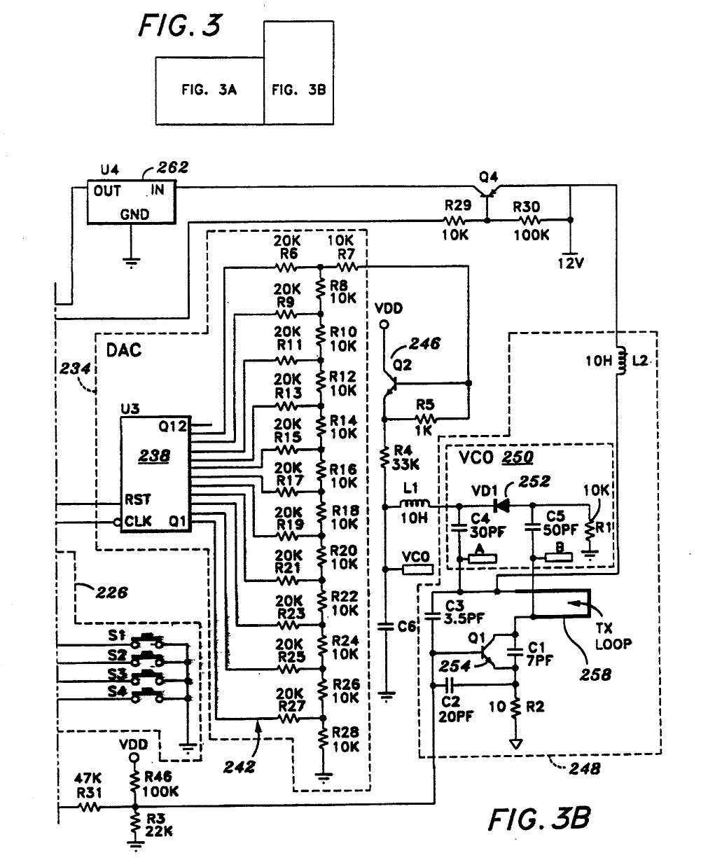

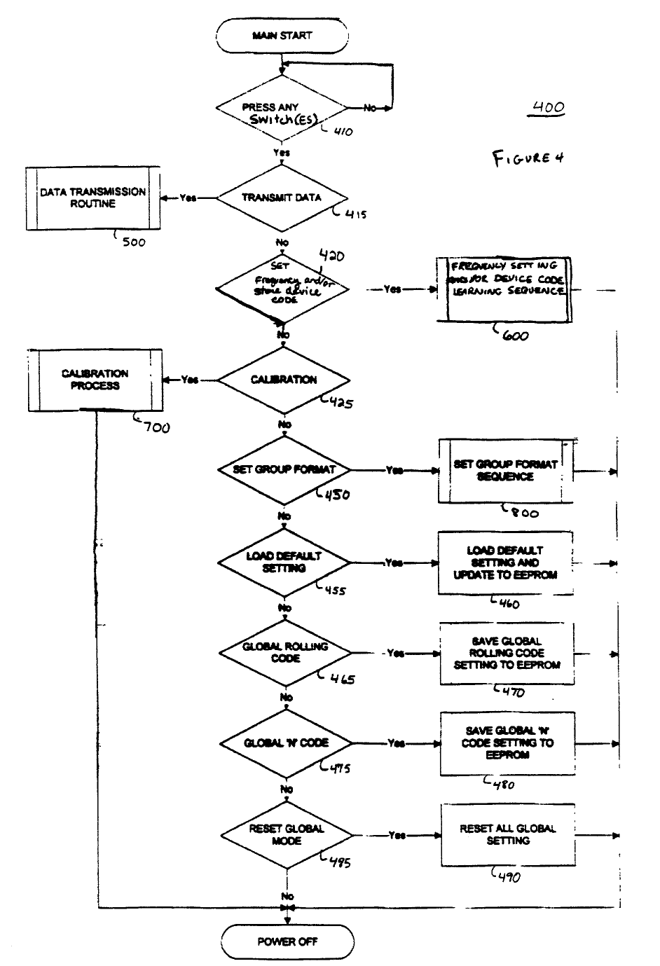

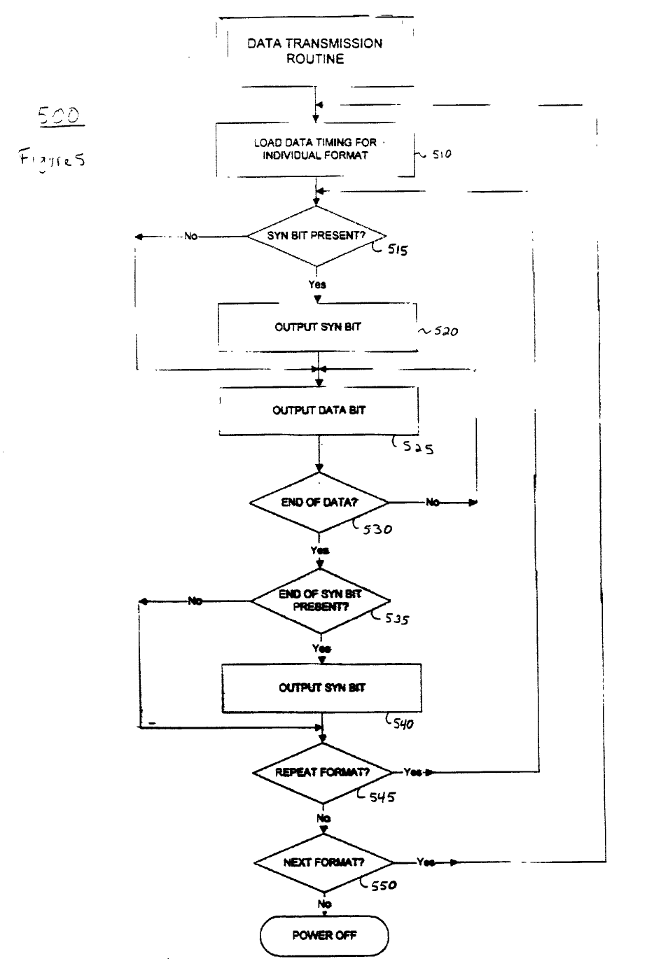

FIG. 4 illustration a flow diagram of a process or method 400 executed by the CPU 210, according to one embodiment of the present invention. Referring to FIG. 4, the process 400 commences at block 410 where the process waits until one or more of the switches S1 to S4 are pressed, after which the process continues to block 415. At block 415, if one of the switches is pressed and held for less than a predetermined time (e.g., less than three seconds), the process moves to block 500 (FIG. 5), where a data transmission routine is invoked to transmit a device code, using one or more transmission formats, at a selected transmission frequency. Otherwise, the process 400 moves to block 420. At block 420, if one of the switches S1 to S4 is pressed and held for more than the predetermined time, the process 400 moves to block 600 (FIG. 6), where the CPU 210 stores a desired transmission frequency and/or a desired device code (from code switch 230) in the non-volatile memory 230, and assigns the stored values to the selected switch (e.g., using a pointer). Otherwise, the method continues to block 425. At block 425, if switches S1 and S3 are pressed and simultaneously held for the predetermined time, the process moves to block 700 where a frequency adjustment or calibration mode is entered. In one embodiment, this mode is only entered when posts 1 and 2 of JP1 are connected together. This typically occurs in the factory.

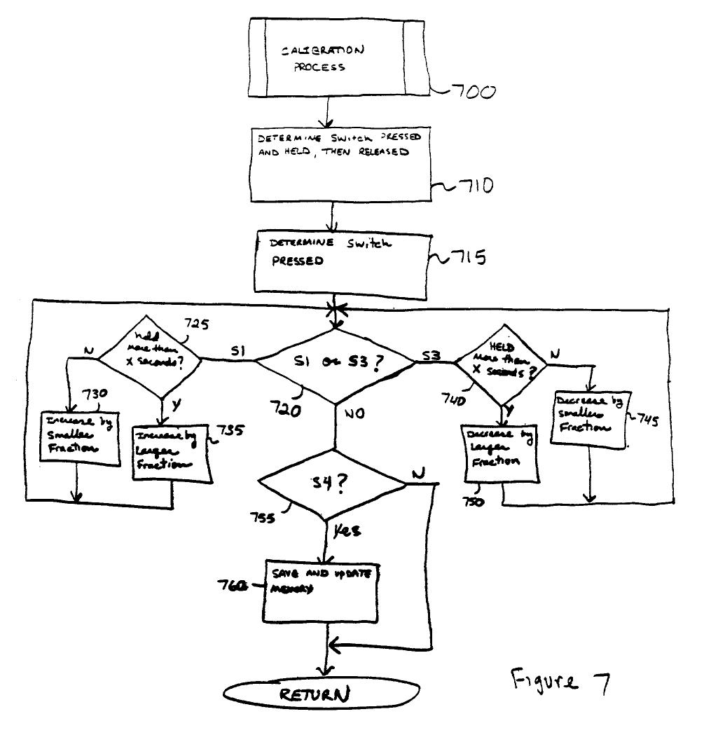

If the calibration mode is not entered, the process 400 moves to block 450. At block 450, if switches S1 and S4 are pressed and simultaneously held for more than the predetermined time, the process 400 moves to block 800 (FIG. 8), where the CPU 210 stores one or more transmission formats or pointers thereto, assigned to a switch, in the non-volatile memory 218. On the other hand, if switches S1 and S4 are not simultaneously held for the predetermined time, the process moves to block 455. At block 455, if switches S1 and S2 are pressed and simultaneously held for more than the predetermined time, the process 400 moves to block 460, otherwise the process continues to block 465. At block 460, the CPU 210 updates the factory default settings to the non-volatile memory 218. In one embodiment, the switches S1, S3, S4, and S2 are reset to transmit signals in the transmission frequencies shown in the first four rows of Table 1, and to transmit the transmission format groups, as shown in the first four rows of Table 2.

At block 465, if switches S3 and S4 are pressed and simultaneously held for more than the predetermined time, the process 400 moves to block 470, where a global rolling code mode is entered, otherwise the process continues to block 475. At block 470, in the global rolling code mode, the CPU 210 stores the global rolling code settings to non-volatile memory 218. In one embodiment, the global rolling code settings include the device code, transmission format(s), transmission frequency (ies), and rolling code algorithm or formula used in the rolling code system, as described in the co-pending application, application Ser. No. 09/023,393.

At block 475, if switches S2 and S3 are pressed and simultaneously held for more than the predetermined time, the process 400 moves to block 480 where a global “N” mode is entered, otherwise the process continues to block 485. At block 480, in the global “N” mode, the CPU 210 stores the global “N” code settings from ROM 222 to non-volatile memory 218. In one embodiment, the global “N” mode is a mode that is compatible with X-10 systems and accessories for controlling, for example, one or more X-10 light modules. In this mode, the functions of switches S1 to S4 are programmed to be compatible with the X-10 systems including turning lights on/off and dimming/brightening lights. It is to be noted that the global “N” mode may be programmed to be compatible with other wireless standards and systems.

At block 485, if switches S2 and S4 are pressed and simultaneously held for more than the predetermined time, the process 400 moves to block 490 where all the global settings are reset, and the transmitter 100 enters the mode prior to entering the global mode. Thus, if the transmitter 100 is in the global rolling code mode or in the global “N” mode, the transmitter 100 goes back to the mode prior to entering one of the global modes. Thus, the CPU 210 reprograms the non-volatile memory 218 with the values prior to entering one of the global modes.

FIG. 5 illustrates a flow diagram of a data transmission method 500, according to one embodiment of the present invention. Referring to FIG. 5, the method 500 commences at block 510 where the data timing sequence for the individual data transmission format is retrieved from non-volatile memory 218 and loaded into a RAM or scratch pad RAM area. The process 500 moves to block 520 where a determination is made as to whether the data transmission format includes a synchronization bit or pulse. If so, the process moves to block 520 where the synchronization bit or pulse is output by the CPU 210 on the PB4 output signal line (FIG. 2). The process then moves to block 525 where a data bit is output by the CPU 210. At block 530, if there are more data bits to transmit, the process moves back to block 525, where the next data bit is output by the CPU 210, otherwise the process moves to block 535. At block 535, if the data transmission format includes a synchronization bit, the CPU 210 outputs an end of synchronization bit (block 540). At block 545, a determination is made as to whether the data format needs to be repeated. If so, blocks 515 to 540 are again executed, otherwise the process moves to block 550. At block 550, if more than one data transmission format is in a data transmission format group (e.g., the data transmission format groups associated with switches S1, S2, and S4 in Table 2), blocks 515 to 545 are executed for the remaining data transmission format(s).

FIG. 6 illustrates a flow diagram of a frequency setting and/or device code learning method 600, according to one embodiment of the present invention. As stated before, this method 600 is invoked when one of switches S1 to S4 is pressed and held for a predetermined time (block 420, FIG. 4), and then released.

Referring to FIG. 6, the process 600 commences with block 610 where the CPU 210 determines which one or more of the switches S1 to S4 are then pressed and held for the predetermined time, and then released. At block 615, the CPU 210 determines the transmission frequency, which is to be assigned to the switch pressed and held at block 420, based on the switch(es) pressed and held at block 610, and according to Table 1. At block 620, the CPU 210 may also read the individual switch settings (device code) of the code switch 230 (FIG. 2). At block 625, the values of the selected transmission frequency and the device code are then programmed/stored in the non-volatile memory 218, by the CPU 210. Instead of storing the value for the transmission frequency (e.g., 300 MHz) in the non-volatile memory 218, the CPU 210 may store a pointer in the memory 218, pointing to the (address) of the value in Table 1, which may be stored in memory 218 or ROM 222.

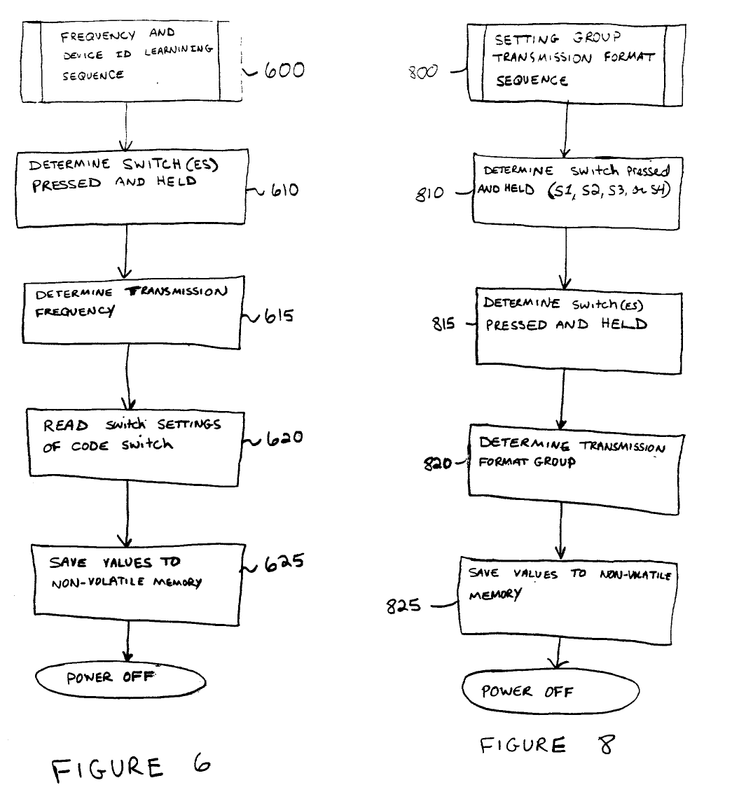

FIG. 7 illustrates a flow diagram of a method 700 for calibrating the transmission frequency, according to one embodiment of the present invention. This process is used to calibrate or trim a desired transmission frequency, and, in one embodiment, is invoked in the factory (e.g., by connecting posts 1 and 2 of JP1 (FIG. 3A). As stated before, this method 700 is invoked when switches S1 and S3 are pressed and held for a predetermined time (block 425, FIG. 4), and then released.

Referring to FIG. 7, the process 700 commences with block 710 where the CPU 210 determines which of the switches S1 to S4 is pressed and held for the predetermined time period, and then released. The transmission frequency assigned to the switch selected in block 710 may then be adjusted. At block 715, the block again determined which one of the switches S1 to S4 is pressed and released. At block 720, if the switches S1 or S3 are pressed, the method 700 moves to block 725 or 740, respectively. At block 725, the method 700 determines whether the switch S1 was held for more than a predetermined time (e.g., 2 seconds). If not, the process moves to block 730 where the transmission frequency assigned to the switch pressed in block 710 is increased by a fractional amount such as, for example, by a 0.001 percent increment. However, if at block 725, switch S1 was held longer than the predetermined time, the transmission frequency is increased by a greater fractional amount (e.g., 10 times more than the normal fractional amount) (block 735). After execution of block 730 or 735, the process moves back to block 720.

Correspondingly, at block 740, the method 700 determines whether the switch S3 was held for more than the predetermined time. If not, the transmission frequency assigned to the switch pressed in block 710 is decreased by a fractional amount (block 745). However, if switch S3 was held longer than the predetermined time, the transmission frequency is decreased by a greater fractional amount (e.g., 10 times more than the normal fractional amount) (block 750). After execution of block 745 or 750, the process moves back to block 720.

In one embodiment, depending on the transmission frequency being adjusted, the transmission frequency is increased or decreased by 70 to 200 kHz (at block 730 or 745), or 700 kHz to 2 MHz (at block 735 or 750). It is to be noted that the resolution/ granularity is a matter of design choice.

If at block 720 neither of switches S1 and S3 are pressed, the process moves to block 755. If, at block 755, switch S4 was pressed, the process continues to block 760 where the value(s) for the transmission frequency, which may have been adjusted, is(are) programmed/stored in the memory 218, and assigned to the switch pressed at block 710. If, at block 755, switch S2 was pressed, signifying a cancel operation, the process skips block 760, and the process 700 ends. Pressing switch S2 cancels the calibration process and prevents any value(s) from being programmed/stored in the memory 218.

FIG. 8 illustrates a flow diagram of a method 800 for setting a transmission format group, according to one embodiment of the present invention. As stated before, this method 800 is invoked when switches S1 and S3 are pressed and simultaneously held for a predetermined time (block 450, FIG. 4), and then released.

Referring to FIG. 8, the process 800 commences with block 810 where the CPU 210 determines which one of the switches S1 to S4 is pressed and held for the predetermined time, and then released. This block determines which switch is to be programmed. At block 815, the CPU 210 determines which one or more of the switches S1 to S4 are pressed and held for the predetermined time, and then released. In the exemplary embodiment described herein, the following switch combinations are supported (Table 2): S1, S3, S4, S2, and S2+S4. In the case of fourteen (14) transmission formats grouped into ten (10) groups, the switch combinations may be S1 through S4, S1+S2, S1+S3, S1+S4, S2+S3, S2+S4, and S3+S4. At block 820, the CPU 210 determines the transmission format grouping selected, which is to be assigned to the switch pressed at block 810, based on the switch(es) pressed and held at block 815 and according to Table 2. At block 825, the values of the selected transmission format(s) in the transmission format group are then programmed/stored in the non-volatile memory 218, by the CPU 210. Instead of storing the value(s) for the transmission formats (e.g., formats 1-3) in memory 218, the CPU 210 may store a pointer in the memory 218, pointing to the (address) of the value(s) in Table 2, which may be stored in memory 218 or ROM 222.

An important aspect of the invention is the capability of programming the carrier frequency, modulation pattern, and device code setting into the memory device of the universal transmitter. Additionally, the universal transmitter allows for programming of multiple frequencies and modulation patterns to multiple switches, which functions to actuate multiple remote device.

While the preceding description has been directed to particular embodiments, it is understood that those skilled in the art may conceive modifications and/or variations to the specific embodiments and described herein. Any such modifications or variations which fall within the purview of this description are intended to be included therein as well. It is understood that the description herein is intended to be illustrative only and is not intended to limit the scope of the invention. Rather the scope of the invention described herein is limited only by the claims appended hereto.

What is claimed is:

1. A transmitter, comprising:
a switch;
a memory programmed to store values associated with the switch, the values being representative of one or more of a device code, modulation format, and transmission frequency; and
a controller coupled to the memory and the switch, the controller to detect actuation of the switch, and, responsive thereto, to retrieve the values from the memory, and to cause transmission of a signal having the device code and the modulation pattern, at the transmission frequency.

2. The transmitter of claim 1 further comprising:
an output circuit coupled to the controller, the controller to control the output circuit to transmit the signal having the device code and the modulation pattern, at the transmission frequency.

3. The transmitter of claim 1 wherein the output circuit includes a digital to analog converter coupled to the controller, an amplifier coupled to the digital to analog converter, a voltage controlled oscillator coupled to the amplifier, and a radio frequency circuit coupled to the voltage controlled oscillator.

4. The transmitter of claim 1 wherein the memory is a programmable memory including one of: an electrically erasable programmable read only memory, non-volatile random access memory, and flash memory.

5. The transmitter of claim 1 further comprising a plurality of switches, each switch associated with respective values stored in the memory such that actuation of a respective switch causes retrieval of the respective values from the memory for transmitting a signal having characteristics based on the values.

6. The transmitter of claim 1 wherein a switch is associated with values by actuating combinations of the one or more switches.

7. The transmitter of claim 5 further comprising a group of a second plurality of switches, each of the second plurality of switches representing one of at least two states, said controller to read the states of the plurality of switches and store values representative of the states of the switches in the memory, in response to actuation of combinations of the plurality of switches.

8. The transmitter of claim 5, wherein the controller to detect actuation of a sequence of the plurality of switches, and store to the memory values representative of a transmission frequency from a plurality of predetermined transmission frequencies.

9. The transmitter of claim 5, wherein the controller to detect actuation of a sequence of the plurality of switches, and store to the memory values representative of a transmission format from a plurality of predetermined transmission formats.

10. A transmitter, comprising:
at least two switches;
a first memory including a plurality of predetermined transmission frequencies, and a plurality of predetermined transmission formats;
a second memory including one or more instructions; and
a controller coupled to the at least two switches and the first and second memories, the controller, in response to the one or more instructions, to detect actuation of a first sequence of the at least two switches, and to store in the first memory a transmission frequency from the plurality of predetermined transmission frequencies, said transmission frequency being associated with a first switch.

11. The transmitter of claim 10 wherein the controller to detect actuation of a second sequence of the at least two switches, and to store in the first memory, a transmission format from the plurality of transmission formats, said transmission format being associated with the first switch.

12. The transmitter of claim 10 wherein the controller to detect actuation of the first switch, and, in response, to retrieve the transmission frequency and the transmission format from the first memory, and to cause transmission of a signal having the transmission format at the transmission frequency.

13. The transmitter of claim 10 further comprising an output circuit including a voltage controlled oscillator coupled to the controller and a radio frequency circuit including an antenna coupled to the voltage controlled oscillator and the controller, the controller to control the output circuit to transmit the signal having the transmission format at the transmission frequency.

14. The transmitter of claim 10 further comprising a code switch coupled to the controller, the code switch including a plurality of selectable switches selectable to provide a device identification code, said controller to detect actuation of a second sequence of the at least two switches, and to store in the first memory the device identification code, said device identification code being associated with the first switch.

15. The transmitter of claim 10 wherein the first memory is a programmable memory including one of: an electrically erasable programmable read only memory, non-volatile random access memory, and flash memory.

16. The transmitter of claim 10 wherein the first and second memories are the same memory.

17. The transmitter of claim 10 wherein the controller to detect actuation of a second sequence of the at least two switches, to store in the first memory values including a device identification code and an algorithm representative of a rolling code system, one or more of said at least two switches being used to transmit rolling code signals.

18. The transmitter of claim 10 wherein the controller to detect actuation of a second sequence of the at least two switches, and, in response, to adjust the transmission frequency associated with the first switch by a predetermined amount, and to store the adjusted transmission frequency in the first memory.

19. A method of programming a transmitter, comprising:
actuating a first sequence of at least two switches;
storing in a memory one or both of a transmission frequency from a predetermined plurality of transmission frequencies and a transmission format from a predetermined plurality of transmission formats;
associating one or both of the transmission frequency and the transmission format to a first switch;
detecting actuation of the first switch; and
transmitting a signal having the transmission format at the transmission frequency.

20. The method of claim 19 further comprising:
actuating a second sequence of the at least two switches;
storing in the memory a device identification code;
associating the device identification code with the first switch;
detecting actuation of the first switch; and
transmitting the signal having the device identification code and the transmission format at the transmission frequency.

21. A transmitter, comprising:
a plurality of switches;
a memory including transmission frequency values defining a transmission frequency range, and a plurality of transmission formats;
a voltage controlled oscillator; and
a controller coupled to the plurality of switches, the memory, and the voltage controlled oscillator, the controller to assign a transmission format to a switch based on user actuation of one or more of the plurality of switches, to detect actuation of the switch, and to control the voltage controlled oscillator to generate a signal having the transmission format, at a transmission frequency that is within the transmission frequency range based on one or more of the transmission frequency values.

22. The transmitter of claim 21 wherein the one or more transmission frequency values being assigned to the switch based on actuation of a sequence of the one or more switches.

23. The transmitter of claim 21 wherein the transmission frequency range include approximately 200 MHz to 1 GHz.

24. A transmitter, comprising:
a plurality of switches;
a memory including a first plurality of predetermined transmission frequency values, and a second plurality of predetermined transmission formats; and
an output circuit including a voltage controlled oscillator (VCO);
a controller coupled to the plurality of switches, memory, and VCO, the controller to (i) detect actuation of a sequence of the plurality of switches, (ii) store in the memory a combination of a transmission frequency value and a transmission format from a plurality of combinations of the first plurality and the second plurality, said combination of the transmission frequency value and transmission format being associated with a first switch, and (iii) control the VCO to transmit a signal having the transmission format at the transmission frequency, in response to actuation of the first switch.
